(19) United States
(12) Patent Application Publication
(10) Pub. No.: US 2021/0025280 A1
(43) Pub. Date: Jan. 28, 2021

(54) TURBINE ROTOR AND METHOD

(71) Applicant: PRATT & WHITNEY CANADA CORP., Longueuil (CA)

(72) Inventors: Larry LEBEL, Vercheres (CA); John E. HOLOWCZAK, S. Windsor, CT (US); Andrew J. LAZUR, Laguna Beach, CA (US)

(21) Appl. No.: 16/837,466

(22) Filed: Apr. 1, 2020

Related U.S. Application Data
(60) Provisional application No. 62/876,977, filed on Jul. 22, 2019.

(51) Int. Cl. F01D 5/28

(52) U.S. Cl. CPC F01D 5/284; F01D 5/18; F01D 5/282

(57) ABSTRACT

A turbine rotor for an aircraft engine includes a plurality of blades compressed by a compression ring made of ceramic matrix composite (CMC). The CMC includes at least one of: monofilaments and silicon carbide fibers. A method of extracting energy from an airflow using a turbine rotor of an aircraft engine is also disclosed.

### CROSS-REFERENCE TO RELATED APPLICATIONS

This application claims priority to U.S. provisional patent application 62/876,977 filed Jul. 22, 2019, the entire contents of which are incorporated by reference herein.

### TECHNICAL FIELD

The application relates to aircraft turbine rotors.

### BACKGROUND

For some aircraft applications, turbine rotors include one or more air passages therethrough for cooling and maintaining the turbine rotors within limits tolerable by the materials of the elements that the prior art turbine rotors are made from. While such turbine rotors may be suitable for their intended purposes, improvements are desirable.

### SUMMARY

In one aspect, there is provided a turbine rotor for an aircraft engine, the turbine rotor comprising: a plurality of blades compressed by a compression ring made of ceramic matrix composite (CMC), the CMC including at least one of: monofilaments and silicon carbide fibers.

In some embodiments, the plurality of blades at their radial outer ends connect directly to the compression ring.

In some embodiments, the compression ring is free from air passages.

In some embodiments, at least some of the monofilaments at least one of: the monofilaments and the silicon carbide fibers are continuous.

In some embodiments, at least some of the monofilaments include aligned silicon carbide grains disposed over a carbon monofilament core.

In some embodiments, the CMC includes both the monofilaments and the silicon carbide fibers, the monofilaments and the silicon carbide fibers extending through the compression ring in a hoop direction.

In some embodiments, the CMC includes one or more of: a glass-ceramic matrix, an oxide matrix, a melt infiltrated matrix, a silicon, a silicon alloy, a chemical vapor deposited matrix, a silicon carbide, a carbon, a silicon nitride, a preceramic polymer infiltration matrix, a pyrolysis-produced matrix, an SiC, an Si—N—C, and an Si—N—C—O.

In another aspect, there is provided a turbine rotor for an aircraft engine, the turbine rotor having a hub rotatable about a rotation axis, a plurality of blades distributed circumferentially about the hub and connected at their radial inner ends to the hub and at their radial outer ends to a compression ring comprising a ceramic matrix composite (CMC), the CMC including a matrix, and fibers supported by the matrix, the fibers extending through the matrix in a hoop direction and including at least one of: silicon carbide fibers, carbon fibers, oxide fibers, polycrystalline fibers, and monofilaments.

In some such embodiments, the plurality of blades at their radial outer ends connect directly to the compression ring.

In some such embodiments, the compression ring is free from air passages extending through the compression ring.

In some such embodiments, at least some of the fibers are continuous.

In some such embodiments, at least some of the fibers include silicon carbide grains disposed over a carbon monofilament core.

In some such embodiments, the silicon carbide grains are aligned silicon carbide grains.

In some such embodiments, the matrix includes one or more of: a glass-ceramic material, a glass-ceramic compound, silicon, silicon alloy, silicon carbide, carbon, silicon nitride, Si—N—C, Si—N—C—O, borosilicate, lithium-aluminosilicate (LAS), barium-aluminosilicate (BAS), barium-magnesium-aluminosilicate (BMAS), a titanium alloy, and a titanium-aluminide alloy.

In some such embodiments, the matrix has a lower stiffness than the fibers.

In some such embodiments, the plurality of blades are made from a CMC.

In some such embodiments, the CMC of the plurality of blades is the CMC of the compression ring.

In another aspect, there is provided a method of extracting energy from an airflow using a turbine rotor of an aircraft engine, comprising: allowing a plurality of blades of the turbine rotor to be rotated by the airflow about a rotation axis while radially compressing the plurality of blades with at least one of: silicon carbide fibers, polycrystalline fibers and monofilaments.

In some embodiments, the compressing the plurality of blades includes compressing the plurality of blades with a compression ring comprising a ceramic matrix composite (CMC), the CMC including the at least one of: the silicon carbide fibers, the polycrystalline fibers and the monofilaments.

In some embodiments, the method comprises supporting the at least one of the silicon carbide fibers, the polycrystalline fibers and the monofilaments with a glass-ceramic matrix.

### DESCRIPTION OF THE DRAWINGS

Reference is now made to the accompanying figures in which:

FIG. 1 is a schematic cross sectional view of an aircraft engine;

FIG. 2 is a schematic elevation view of a turbine rotor of the aircraft engine of FIG. 1;

FIG. 3 is a schematic cross-section of the turbine rotor of FIG. 2; and

FIG. 4 is a schematic flow diagram showing a method of extracting energy from an airflow using a turbine rotor of an aircraft engine.

### DETAILED DESCRIPTION

While the turbine rotor technology of the present application is described herein with respect to a particular type of aircraft engine, the turbine rotor technology of the present application may likewise be used with other types of aircraft engines and turbines.

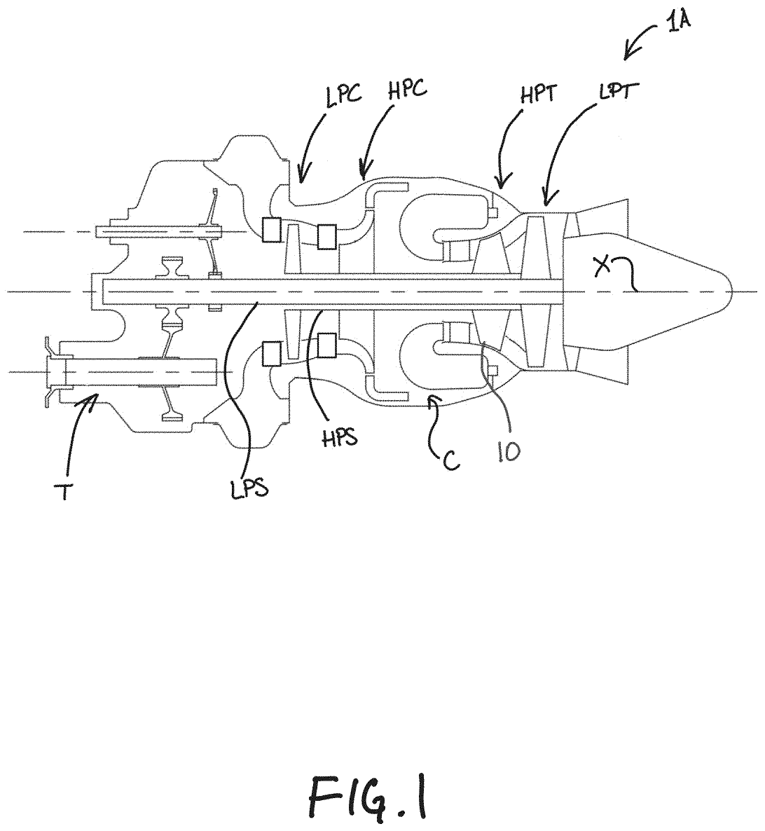

FIG. 1A illustrates an aircraft engine 1A, which may be part of an aircraft, such as a conventional aircraft for example. In this example, the engine 1A is a turboshaft engine 1A, but could be any other type of aircraft engine. In this embodiment, the engine 1A includes in serial flow communication a low pressure compressor section (LPC) and a high pressure compressor section (HPC) for pressurizing air, a combustor (C) in which the compressed air is mixed with fuel and ignited for generating an annular stream of hot combustion gases, a high pressure turbine section (HPT), and a lower pressure turbine section (LPT). The respective pairs of the compressor and turbine sections are interconnected via respective independently rotatable low pressure and high pressure spools (LPS), (HPS). The engine 1A includes a transmission (T) driven by the low pressure turbine section (LPT) for outputting motive power to an aircraft.

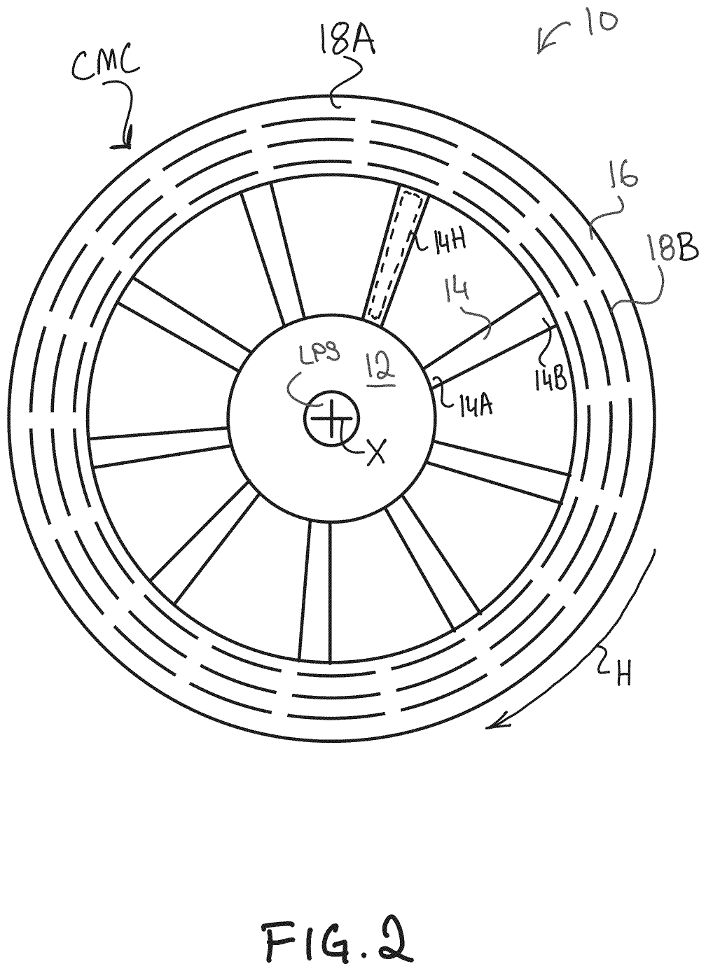

FIG. 2 illustrates a turbine rotor 10, one or more of which may be used in the low pressure turbine section (LPT) and/or in the high pressure turbine section (HPT) of the engine 1A. In this embodiment, the turbine rotor 10 includes a hub 12 rotatable about a rotation axis (X) of the engine 1A, and blades 14 connected to the hub 12. More particularly, in the example embodiment shown in FIG. 2, the hub 12 is connected to the low pressure spool (LPS) to rotate about the rotation axis (X) of the low pressure spool (LPS). Where the turbine rotor 10 is used in the high pressure turbine section (HPT) for example, the hub 12 may be connected to the high pressure spool (HPS) to rotate about the rotation axis (X) of the high pressure spool (HPS). In some embodiments, the hub 12 may be made of any suitable material and/or using any suitable manufacturing method.

The hub 12 is therefore not described herein in detail. As an example, in some embodiments the hub 12 may be constructed to be sufficiently elastically deformable so to absorb thermal radial expansion and contraction of the blades 14 that may occur during operation of the turbine rotor 10. In such embodiments, the particular construction and/or materials and/or dimensions of the hub 12 may be selected to provide for particular elastic deformation characteristics of the hub 12 that are suitable to the particular construction, and hence thermal radial expansion and contraction characteristics, of the blades 14. As an example, in some such cases, conventional engineering and manufacturing principles may be used to select a construction, materials, and dimensions of the hub 12 to suit a particular construction, materials, and dimensions of the blades 14, so that a given threshold thermal radial expansion and contraction of the blades 14 may cause solely elastic (as opposed to plastic) deformation of the hub 12.

Still referring to FIG. 2, the blades 14 are distributed circumferentially about the hub 12 and are connected at their radial inner ends 14A to the hub 12. At their radial outer ends 14B, the blades 14 are connected directly to a compression ring 16 of the turbine rotor 10. As used herein, the term “directly” when used with respect to a first element being connected to second element means that the first element contacts the second element and no other elements are interposed between the first and second elements. In the present embodiment, the expression that the radial outer ends 14B of the blades 14 are connected directly to the compression ring 16 means that there are no air passages disposed between the radial outer ends 14B of the blades 14 and the compression ring 16.

In some embodiments, one or more elements may be disposed between one or more of the blades 14 and the compression ring 16, however in at least some embodiments such additional elements may likewise be free from air passages. In the present embodiment, the compression ring 16, and hence the turbine rotor 10, may also be free from air passages extending through the compression ring 16 (i.e. the compression ring 16 is a solid element with no air passages defined therethrough).

In at least some applications where a prior art turbine rotor may need to have air passages to prevent overheating of the prior art turbine rotor, the turbine rotor 10 according to the present technology may need to define fewer and/or smaller air passages through the compression ring 16, and in some embodiments may not need to define any air passages through the compression ring 16 and/or between the blades 14 and the compression ring 16. In an aspect, the removal/omission of all air passages, and in some cases a reduction of a number and/or size of air passages, may help improve an operating efficiency of the turbine rotor 10 and/or may help reduce complexity of manufacturing of the turbine rotor 10.

In some such applications, the removal and/or omission and/or reduction of size and/or number of air passages from the turbine rotor 10 may be enabled by the construction of the various embodiments of the turbine rotor 10, as described herein next. In at least some cases and/or applications, the removal and/or omission and/or reduction of size and/or number of air passages from the turbine rotor 10 may be enabled by the construction of the various embodiments of the compression ring 16, as described herein next. In another aspect, in at least some embodiments and for at least some applications, the construction of the various embodiments of the compression ring 16 and/or the material of the blades 14 as described herein may allow the blades 14 to be made hollow, as shown with respect to one of the blades 14 with dashed lines labeled 14H. Hollow blades 14 may allow to reduce a weight of the turbine rotor 10. In yet another aspect, the construction of the various embodiments of the compression ring 16 and/or the material of the blades 14 as described herein may allow in at least some applications for the compression ring 16 to be made to compress the blades 14 to a lesser degree, and/or to be made smaller and/or lighter, relative to at least some prior art rotors in the same applications, while not materially impacting the toughness and/or resistance to impacts of the blades 14.

In the present embodiment, the blades 14 and the compression ring 16 are made from a ceramic matrix composite (CMC). More particularly, the CMC of the blades 14 is the same as the CMC of the compression ring 16. While this may provide advantages in some applications, in other embodiments, the CMC of the blades 14 and the CMC of the compression ring 16 may be different. In some embodiments, the blades 14 may be made from a different material that is not a CMC.

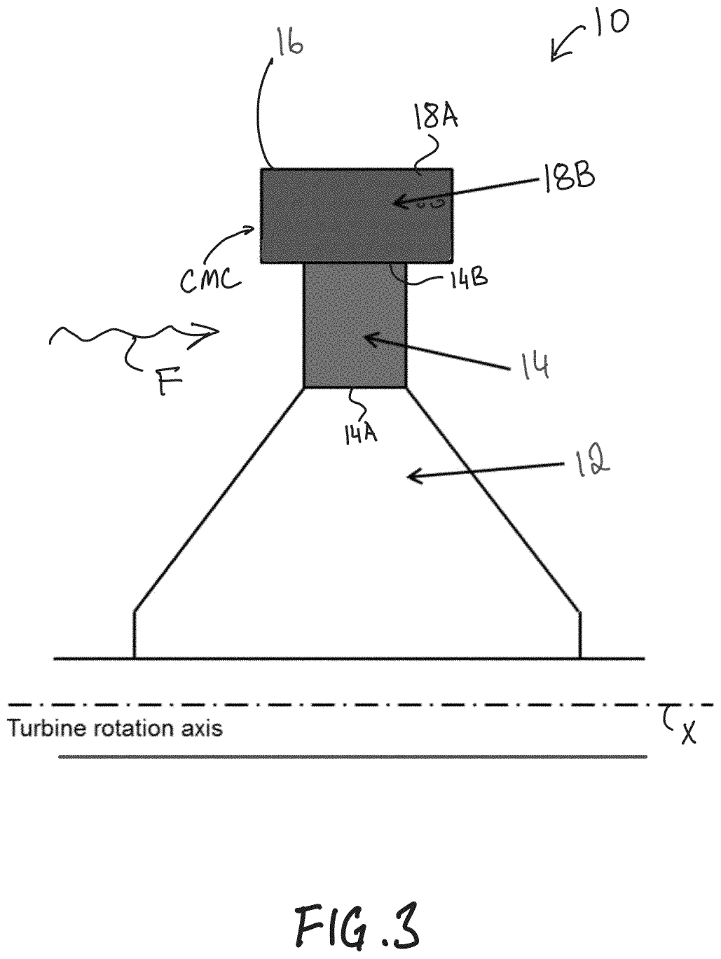

Now also referring to FIG. 3, in the present embodiment, the CMC of the compression ring 16 includes a matrix 18A and fibers 18B disposed inside and supported by the matrix 18A. In some embodiments, the matrix 18A may be, or may include one or more of a glass-ceramic matrix, an oxide matrix, a melt infiltrated matrix (for example, a silicon or a silicon alloy), a chemical vapor deposited matrix (including, for example, silicon carbide, carbon, and/or silicon nitride), a preceramic polymer infiltration matrix, and a pyrolysis-produced matrix (including, for example, SiC, Si—N—C, Si—N—C—O).

In some embodiments, the matrix 18A may include one or more of (i.e. one of, or a combination of at least two of): a glass-ceramic material, a glass-ceramic compound, silicon, silicon alloy, silicon carbide, carbon, silicon nitride, Si—N—C, Si—N—C—O, borosilicate, lithium-aluminosilicate (LAS), barium-aluminosilicate (BAS), barium-magnesium-aluminosilicate (BMAS), a titanium alloy, and a titanium-aluminide alloy.

As shown schematically with dashed lines in FIG. 2, the fibers 18B in this embodiment are continuous and extend through the matrix 18A in a hoop (also known as circumferential) direction (H). In some embodiments, at least some of the fibers 18B may not be continuous. In some embodiments, the fibers 18B may include one or more of (i.e. at least one of, or a combination of at least two of): silicon carbide fibers, carbon fibers, oxide fibers, polycrystalline fibers, and monofilaments.

For example, in some embodiments, all of the fibers 18B are monofilaments. As another example, in some embodiments, the fibers 18B include both monofilaments and silicon carbide fibers. In some such embodiments, the monofilaments may include silicon carbide grains disposed over a carbon monofilament core. In some such embodiments, the silicon carbide grains may be aligned silicon carbide grains that may be grown on the respective carbon monofilament cores using a chemical vapor deposition process. One non-limiting example of suitable monofilaments which may be used are SCS-Ultra™ and/or SCS-6™ monofilaments produced by Specialty Materials, Inc.

In some such embodiments, the fibers 18B may also include (e.g. may be mixed with) other silicon carbide fibers (such as for example fibers from the Nicalon® family of fibers produced by NGS Fibers Unlimited, or the Tyranno® fibers produced by UBE Industries). In each given embodiment, the fibers 18B may be selected to support the centrifugal loading that may be experienced by the blades 14 the particular application(s) of that embodiment. It is contemplated that in each given embodiment, the fibers 18B may be arranged in any architecture suitable for the particular application(s) in which the turbine rotor 10 is to be used. One non-limiting example of an architecture suitable for at least some applications utilizes a graded elastic modulus of the fibers 18B.

It is contemplated that in some applications, the fibers 18B may not include monofilaments. In some embodiments, the diameters of the fibres 18B may be between 80 and 140 microns. In some embodiments, the stiffness and/or the diameters of the fibres 18B may be different.

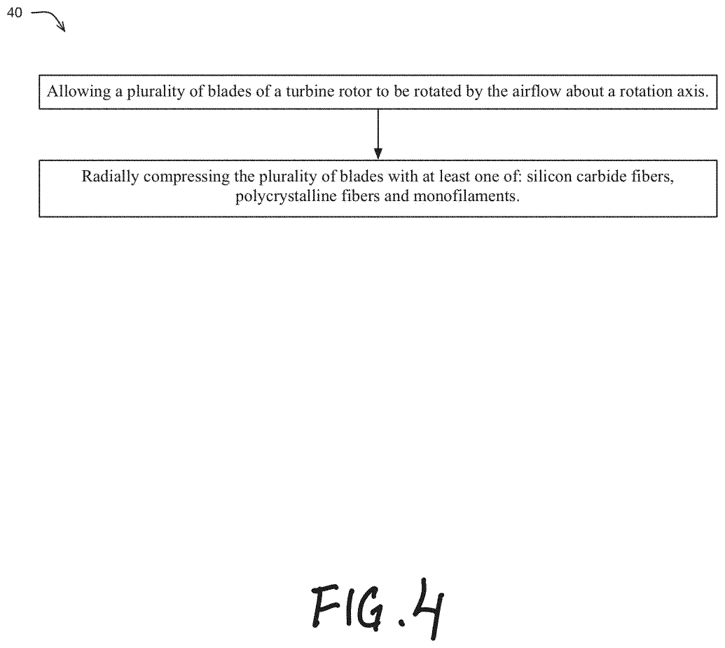

Wth the above structure in mind, and now referring to FIGS. 3 and 4, the present technology provides a method 40 of extracting energy from an airflow (F) using a turbine rotor 10 of an aircraft engine 1A. In some embodiments, the method 40 includes allowing a plurality of blades 14 of the turbine rotor 10 to be rotated by the airflow (F) about a rotation axis (X), while radially compressing, as shown with arrow (C) in FIG. 3, the plurality of blades 14 with at least one of: silicon carbide fibers, polycrystalline fibers and monofilaments (shown schematically with reference numeral 18B in FIG. 3).

As seen from the structure above, in some embodiments of the method 40, wherein the compressing the plurality of blades 14 includes compressing the plurality of blades 14 with a compression ring 16 comprising a ceramic matrix composite (CMC). Also as seen above, in some such embodiments, the CMC includes the at least one of: the silicon carbide fibers, the polycrystalline fibers and the monofilaments 18B. Also as seen above, in some such embodiments, the method 40 includes supporting the at least one of the silicon carbide fibers, the polycrystalline fibers and the monofilaments with a glass-ceramic matrix 18A.

The various embodiments of the turbine rotor 10 described above may be made using conventional engineering principles and manufacturing techniques. As a non-limiting example, the particular shape(s) of the blades 14 for a particular application that a given embodiment of the turbine rotor 10 is to be used for may be selected from conventional shape(s) known for that particular application. The above description is meant to be exemplary only. One skilled in the art will recognize that changes may be made to the embodiments described without departing from the scope of the technology disclosed herein.

For example, in some embodiments, the blades 14 may be coated with one or more suitable conventional coatings to provide at least some protection against oxidation. As another example, in some embodiments, the compression ring 16 may have a different cross-section, such as a non-rectangular cross-section. As yet another example, in some applications, the fibers 18B may have various different distributions of the fiber filaments in the compression ring 16 cross-section, including different fiber density variations, different fiber size variations, different fiber type variations. As yet another example, in some applications, the interface(s) between the blades 14 and the compression ring 16 may be different. Yet other modifications will also become apparent in light of the foregoing description and figures.

1. A turbine rotor for an aircraft engine, the turbine rotor comprising: a plurality of blades compressed by a compression ring made of ceramic matrix composite (CMC), the CMC including at least one of: monofilaments and silicon carbide fibers.

2. The turbine rotor of claim 1, wherein the plurality of blades at their radial outer ends connect directly to the compression ring.

3. The turbine rotor of claim 2, wherein the compression ring is free from air passages.

4. The turbine rotor of claim 1, wherein at least some of the monofilaments and at least one of: the monofilaments and the silicon carbide fibers are continuous.

5. The turbine rotor of claim 1, wherein at least some of the monofilaments include aligned silicon carbide grains disposed over a carbon monofilament core.

6. The turbine rotor of claim 1, wherein the CMC includes both the monofilaments and the silicon carbide fibers, the monofilaments and the silicon carbide fibers extending through the compression ring in a hoop direction.

7. The turbine rotor of claim 1, wherein the CMC includes one or more of: a glass-ceramic matrix, an oxide matrix, a melt infiltrated matrix, a silicon, a silicon alloy, a chemical vapor deposited matrix, a silicon carbide, a carbon, a silicon nitride, a preceramic polymer infiltration matrix, a pyrolysis-produced matrix, an SiC, an Si—N—C, and an Si—N—C—O.

8. A turbine rotor for an aircraft engine, the turbine rotor having a hub rotatable about a rotation axis, a plurality of blades distributed circumferentially about the hub and connected at their radial inner ends to the hub and at their radial outer ends to a compression ring comprising a ceramic matrix composite (CMC), the CMC including a matrix, and fibers supported by the matrix, the fibers extending through the matrix in a hoop direction and including at least one of: silicon carbide fibers, carbon fibers, oxide fibers, polycrystalline fibers, and monofilaments.

9. The turbine rotor of claim 8, wherein the plurality of blades at their radial outer ends connect directly to the compression ring.

10. The turbine rotor of claim 9, wherein the compression ring is free from air passages extending through the compression ring.

11. The turbine rotor of claim 8, wherein at least some of the fibers are continuous.

12. The turbine rotor of claim 8, wherein at least some of the fibers include silicon carbide grains disposed over a carbon monofilament core.

13. The turbine rotor of claim 12, wherein the silicon carbide grains are aligned silicon carbide grains.

14. The turbine rotor of claim 8, wherein the matrix includes one or more of: a glass-ceramic material, a glass-ceramic compound, silicon, silicon alloy, silicon carbide, carbon, silicon nitride, Si—N—C, Si—N—C—O, borosilicate, lithium-aluminosilicate (LAS), barium-aluminosilicate (BAS), barium-magnesium-aluminosilicate (BMAS), a titanium alloy, and a titanium-aluminide alloy.

15. The turbine rotor of claim 8, wherein the matrix has a lower stiffness than the fibers.

16. The turbine rotor of claim 8, wherein the plurality of blades are made from a CMC.

17. The turbine rotor of claim 16, wherein the CMC of the plurality of blades is the CMC of the compression ring.

18. A method of extracting energy from an airflow using a turbine rotor of an aircraft engine, comprising: allowing a plurality of blades of the turbine rotor to be rotated by the airflow about a rotation axis while radially compressing the plurality of blades with at least one of: silicon carbide fibers, polycrystalline fibers and monofilaments.

19. The method of claim 18, wherein the compressing the plurality of blades includes compressing the plurality of blades with a compression ring comprising a ceramic matrix composite (CMC), the CMC including the at least one of: the silicon carbide fibers, the polycrystalline fibers and the monofilaments.

20. The method of claim 18, comprising supporting the at least one of the silicon carbide fibers, the polycrystalline fibers and the monofilaments with a glass-ceramic matrix.
